(19) United States
(12) Patent Application Publication
(10) Pub. No.: US 2009/0165018 A1
(43) Pub. Date: Jun. 25, 2009

(54) LEADER ELECTION

(76) Inventors: Flavio P. Junqueira, Barcelona (ES); Benjamin C. Reed, Morgan Hill, CA (US)

Correspondence Address: BERKELEY LAW & TECHNOLOGY GROUP LLP, 17933 NW EVERGREEN PARKWAY, SUITE 250, BEAVERTON, OR, 97006, US

(21) Appl. No.: 11/961,381

(22) Filed: Dec. 20, 2007

(51) Int. Cl. G06F 3/00; G06F 15/16

(52) U.S. Cl. 719/313; 709/201

(57) ABSTRACT

The subject matter disclosed herein relates to election of a leader from a group of processes.

### BACKGROUND

1. Field

The subject matter disclosed herein relates to election of a leader from a group of processes.

2. Information

Distributed processing techniques may be applied to provide robust computing environments that are readily accessible to other computing platforms and like devices. Systems, such as server farms or clusters, may be configured to provide a service to multiple clients or other like configured devices.

As the size of servicing systems has grown to encompass many servers the size and load of the network services have also grown. It is now common for network services to span multiple servers for availability and performance reasons.

One of the reasons and benefits for providing multiple servers is to allow for a more fault-tolerant computing environment. As the number of devices increases and/or other aspects of the distributed service complexity increases, however, so too may the communications and/or processing requirements increase to support the desired fault tolerance capability.

For example, leader election may be used in distributed processing systems to allow for a more fault-tolerant computing environment. In distributed processing systems, it is often the case that processes need to elect one distinguished process as a coordinator or leader. Such a leader may accomplish tasks or coordinate tasks on behalf of the group of processes. Use of leader election may allow distributed processing systems to tolerate failures of the coordinator without halting the system upon such an event. For example, in atomic broadcast algorithms, being able to eventually agree upon a correct leader may be necessary to guarantee that the system eventually makes progress. Further, some coordination services may requires a leader to order incoming requests; therefore, upon the failure of a leader, it may be necessary to elect a new leader, otherwise the system may not make progress.

### DESCRIPTION OF THE DRAWING FIGURES

Claimed subject matter is particularly pointed out and distinctly claimed in the concluding portion of the specification. However, both as to organization and/or method of operation, together with objects, features, and/or advantages thereof, it may best be understood by reference to the following detailed description when read with the accompanying drawings in which:

FIG. 1 is a flow diagram illustrating a procedure for election of a leader from a group of processes in accordance with one or more embodiments; and

FIG. 2 is a schematic diagram of a computing platform in accordance with one or more embodiments.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized and structural and/or logical changes may be made without departing from the scope of claimed subject matter. It should also be noted that directions and references, for example, up, down, top, bottom, and so on, may be used to facilitate the discussion of the drawings and are not intended to restrict the application of claimed subject matter. Therefore, the following detailed description is not to be taken in a limiting sense and the scope of claimed subject matter defined by the appended claims and their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail so as not to obscure the claimed subject matter.

Fault-tolerant distributed services may present limited scalability and performance capabilities. Such limitations may occur, for example, due to the complexity of the protocols used to maintain the consistency of processes composing such services. Such consistency protocols may take several forms. For example, leader election may be used in distributed processing systems to allow for a more fault-tolerant computing environment. In distributed processing systems, it is often the case that processes need to elect one distinguished process as a coordinator or leader. Such a leader may accomplish tasks or coordinate tasks on behalf of the group of processes. Use of leader election may allow distributed processing systems to tolerate failures of the coordinator without halting the system upon such an event.

For example some distributed processing systems may require a leader to order incoming requests to facilitate consistency between a number of replicas of a database. Accordingly, upon the failure of a leader, it may be necessary to elect a new leader, otherwise the system may not make progress. In such a distributed processing system it may be advantageous to elect a leader that has the highest transaction identifier among all functional processes, although not strictly necessary. As used herein the term “transactional identifier” may refer to an identifier based, at least in part, on identifying a given update of a given process, such as for example from a client, and as used herein the terms “largest” or “greatest” with respect to a transactional identifier may refer to identifying the most current update of a given process. Further, some distributed processing systems may operate as asynchronous systems. As used herein the term “asynchronous systems” may refer to systems in which there may be no actual bounds on the amount of time for a message to be delivered, and processes may make progress at different speeds.

Unfortunately, it is a well accepted understanding that it is difficult to always eventually elect a correct process in asynchronous systems. For example, due to asynchronous communications between processes participating in an election it may be difficult to reach a consensus leader selection in such asynchronous systems. In the embodiments described herein, however, procedures for leader elections are described below that may eventually elect a leader in many cases.

Additionally, sometimes, upon stringent conditions, correct processes may either not agree upon a leader or elect a faulty leader. The procedures for leader elections described below are based on a mix of theoretical results and practical assumptions. Such a leader election procedure may operate by having processes broadcasting their most current transaction identifier in a leader proposal. Such a leader proposal essentially operates as a given process voting for itself in the leader election and broadcasting a criterion for the other processes to evaluate the validity of such a vote. For example, leader election procedure may operate by having processes broadcasting both their process identifiers, to identify the process, as well as their most current transaction identifier, to identifying how recently the process has been updated. As used herein the term “process identifier” may refer to a unique identifier assigned to only a single process capable of distinguishing and/or identifying one process from another. Upon the reception of a pair of a process identifier and a transaction identifier, a given process may decide to change its vote. For example, a given process may decide to change its vote to send an updated leader proposal if such an updated leader proposal would succeed its current leader proposal based, at least in part, on any received transaction identifiers from other processes. Such procedures for leader elections are described in greater detail below.

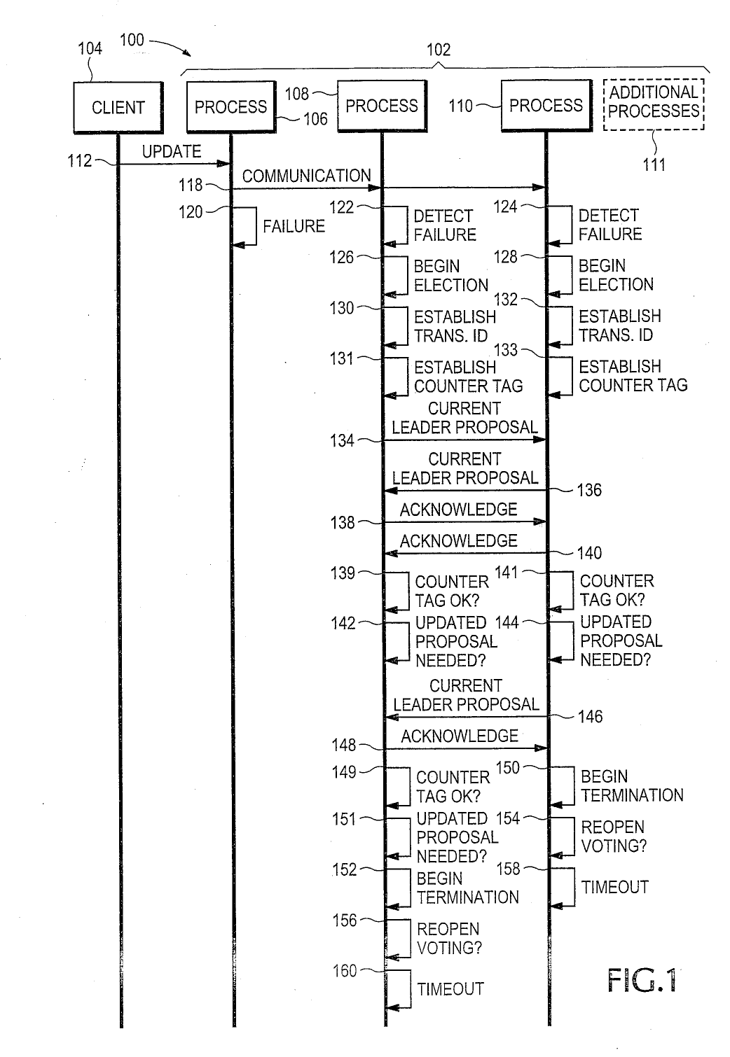

Procedure 100 illustrated in FIG. 1 may be used to perform a leader election in accordance with one or more embodiments, for example, although the scope of claimed subject matter is not limited in this respect. Additionally, although procedure 100, as shown in FIG. 1, comprises one particular order of actions, the order in which the actions are presented does not necessarily limit claimed subject matter to any particular order. Likewise, intervening actions not shown in FIG. 1 and/or additional actions not shown in FIG. 1 may be employed and/or actions shown in FIG. 1 may be eliminated, without departing from the scope of claimed subject matter.

Procedure 100 depicted in FIG. 1 may in alternative embodiments be implemented in software, hardware, and/or firmware, and may comprise discrete operations. As illustrated, procedure 100 governs the operation of a group of processes 102. Members of group of processes 102 may communicate with a client 104 to receive updated information. Process 106 from group of processes 102 may have been previously designated as the leader of group of processes 102. Such a leader may accomplish tasks or coordinate tasks on behalf of the group of processes. For example, client 104 may send updated information to a designated leader, such as for example process 106. In such a case, the designated leader, such as for example process 106, may coordinate with members of group of processes 102 to order and/or arrange execution of an update to a local database based at least in part on such received updated information from client 104. As discussed above, leader election may be used in distributed processing systems to allow for a more fault-tolerant computing environment. In the event that the leader fails, a new leader may be elected.

As leader, process 106 may provide communications 118 to process 108, process 110, and/or other processes of group of processes 102. For example, members of group of processes 102 may communicate with a designated leader, such as for example process 106, to receive updated information. Members of group of processes 102 may track such updates via a transactional identifier, which will be discussed in further detail below. As shown here, processes 108 and 110 may receive updates via communications 118 at different times. As the updates via communications 118 are received by processes 108 and 110 at different times, the transactional identifiers of processes 108 and 110 may have different values. As illustrated, for example, by the dashed lined box 111, group of processes 102 may include additional like processes.

As leader, process 106 may operate to failure 120, process 108, process 110, and/or other processes of group of processes 102 may perform a recognition at actions 122 and 124, respectively. At actions 122 and 124, processes 108, 110 may respectively recognize that communications 118 from the leader process 106 have ceased, indicating that process 106 has failed, for example. In asynchronous systems, such a recognition of the failure by process 108, process 110, and/or other processes of group of processes 102 may not necessarily occur at the same time. After recognition of the failure of the leader, process 108, process 110, and/or other processes of group of processes 102 may trigger an election to begin at actions 126, 128, respectively. If not done previously, process 110, and/or other processes of group of processes 102 may establish a transaction identifier at actions 130, 132, respectively.

Additionally or alternatively, such a current leader proposal may further comprise a current counter tag. As used herein the term “counter tag” includes information and/or instructions capable of identifying a given election cycle. At actions 131, 133, processes 108, 110 may respectively establish a counter tag. As will be discussed in more detail below, processes 108, 110 may respectively establish a counter tag so that recipients of a leader proposal with such a counter tag may identify such a leader proposal as being either designated for a past election cycle or designated for the current election cycle. Alternatively or additionally, processes 108, 110 may respectively establish a counter tag at any other suitable time. For example, processes 108, 110 may respectively establish a counter tag after termination of a past election, and/or may respectively establish a counter tag prior to initiating a new election.

At the beginning of an election cycle, process 108, process 110, and/or other processes of group of processes 102 may communicate a current leader proposal. For example, process 108 may broadcast a leader proposal to process 110 at action 134. Such a current leader proposal may comprise a current process identifier and a current transactional identifier of process 108. As discussed above, as used herein the term “process identifier” may refer to a unique identifier assigned to only a single process capable of distinguishing and/or identifying one process from another. As discussed above, as used herein the term “transactional identifier” may refer to an identifier based, at least in part, on identifying a given update of a given process to a client 104, and as used herein the terms “largest” or “greatest” with respect to a transactional identifier may refer to identifying the most current update of a given process. Accordingly, process 108 may broadcast a current leader proposal where the current process identifier operates as a vote for itself and where the current transactional identifier operates as criteria to quantify the validity of the claim of process 108 to be elected leader of group of processes 102.

Similarly, process 110 may broadcast a leader proposal to process 108 at action 136. Accordingly, process 110 may broadcast a current leader proposal where the current process identifier operates as a vote for itself and where the current transactional identifier operates as criteria to quantify the validity of the claim of process 110 to be elected leader of group of processes 102.

At action 138, process 108 may receive an acknowledgement from process 110 that the current leader proposal from process 108 was received. process 108 may then end the communication of the current leader proposal to process 110 based on the acknowledgement of receipt. Similarly, at action 140, process 110 may end the communication of the current leader proposal to process 108 based on an acknowledgement of receipt.

At actions 139, 141, processes 108, 110 may respectively discard or approve votes based, at least in part, on the counter tags on leader proposals being either designated for a past election cycle or designated for the current election cycle. For example, processes 108 may compare a received counter tag from the received leader proposal from process 110 to the current counter tag of processes 108. In such a comparison, processes 108 may ignore the received leader proposal from process 110 if the received counter tag from process 110 identifies a past election cycle. Alternatively or additionally, in such a comparison, processes 108 may begin an updated election cycle if the current counter tag of processes 108 identifies a past election cycle as compared to the received counter tag from process 110.

At action 142, process 108 may compare a received leader proposal from process 110 and/or other processes of group of processes 102 to the current leader proposal of the process 108 to determine whether process 108 needs to prepare and communicate an updated leader proposal to change its vote. For example, process 108 may determine that no updated leader proposal is needed if the received leader proposal includes a received transactional identifier that is not more current than the current transactional identifier of process 108.

Likewise, at action 144, process 110 may compare a received leader proposal from process 108 and/or other processes of group of processes 102 to the current leader proposal of the process 110 to determine whether process 110 needs to prepare and communicate an updated leader proposal to change its vote. For example, process 110 may prepare and communicate an updated leader proposal if a received leader proposal includes a received transactional identifier that is more current than the current transactional identifier of process 108, as illustrated at action 146. Such an updated leader proposal may be based, at least in part, on the received leader proposal from process 108 and/or other processes of group of processes 102. For example, such an updated leader proposal of process 110 may further comprise an updated transactional identifier based, at least in part, on the received transactional identifier from process 108. Additionally or alternatively, such an updated leader proposal of process 110 may further comprise an updated process identifier based, at least in part, on the received process identifier from process 108. At action 148, process 110 may end the communication of the updated leader proposal to process 108 based on an acknowledgement of receipt from process 108.

At action 149 process 108 may discard or approve such a received updated leader proposal based, at least in part, the counter tag on the updated leader proposal being either designated for a past election cycle or designated for the current election cycle. Additionally, at action 151, process 108 may compare such a received updated leader proposal from process 110 to the current leader proposal of the process 108 to determine whether process 108 needs to prepare and communicate an updated leader proposal to change its vote.

Once a process from group of processes 102 determines that an election cycle has ended, the process selects a leader from the group of processes based, at least in part, on an updated transactional identifier indicating the process with the most current update. For example, at actions 150, 152, processes 110, 108 may respectively begin a termination of the selection of leader from group of processes 102 based, at least in part, on receiving a current and/or updated leader proposal from every process in group of processes 102. Such a termination of the selection of leader from group of processes 102 may occur instantaneously. For example, such a termination of the selection of leader from group of processes 102 may occur instantaneously in response to receipt of a current and/or updated leader proposal from every process in group of processes 102. Once a process from group of processes 102 determines that it is the elected leader after an election cycle has ended, such a leader process may update every process in group of processes 102. For example, such a leader process may possess the most up to date information from client 104 and may update the process in group of processes 102. Such an update from a leader process may be utilized to order and/or arrange execution of an update to a local database by the processes in group of processes 102. For example, if failure 120 of a leader process 102 were to occur while a communication 118 is in process, process 108 may receive a complete communication 118 while process 110 may not have received a complete communication 118. In such a case, process 108 may be elected as leader based on having received the most recent communication 118.

Additionally or alternatively, at actions 150, 152, processes 110, 108 may respectively begin a termination of the selection of leader from group of processes 102 based, at least in part, on receiving a current and/or updated leader proposal from at least a quorum of group of processes 102. For example, procedure 100 may guarantee that eventually all non-faulty processes converge to the same leader, although no process may individually know when such a state has been reached. Guaranteeing termination and agreement among non-faulty processes implies a solution to consensus, and consensus may not be solved in purely asynchronous systems as described herein. Accordingly, to overcome such a termination problem, procedure 100 may rely upon failure detection. Such failure detection may include a process terminating an election cycle if a process believes that it has received messages from all non-faulty processes reflecting changes in their local states. Thus, processes may individually decide whether they have participated in the election for enough time. Once a process decides that it has participated for enough time, it may decide upon its proposed leader. If a quorum of processes decides upon the same leader, then the election may result in a new leader; otherwise, a new execution cycle may be triggered. By the definition of a quorum system, quorums intersect, therefore there may not be two quorums electing different leaders, even if their leader proposals disagree. Thus, even if processes may decide to terminate prematurely, two quorums supporting different leaders may be avoided, although there may be no entire quorum supporting one leader. Procedure 100 may operate to have the processes of a group of processes run in parallel until there is a confirmation that the election cycle has ended. Such an election cycle may give more time for procedure 100 to converge, and correct processes may simply revisit their leader proposals if they notice that group of processes 102 has not been able to complete the leader election cycle with an elected leader.

Such a termination of the selection of leader from group of processes 102 may occur after a set timeout period after a quorum has been reached. Such a termination of the selection of leader from group of processes 102 may occur after a set timeout period if a current and/or updated leader proposal is not received from every process in group of processes 102. For example, at actions 154, 156, processes 110, 108 may respectively cancel the timeout period and reopen the selection. Such a reopening of the selection may occur at actions 154, 156 in response to receipt of a current and/or updated leader proposal that includes a received transactional identifier that is more current than the current transactional identifier of processes 110, 108 respectively. If no leader proposal is received during the timeout period with a higher transactional identifier, then processes 110, 108 may respectively complete the timeout at actions 154, 156, respectively and end the election cycle.

A suitable timeout period may be determined based, at least in part, on the dynamics of a given group of processes 102. For example, it is possible under heavy network traffic and faulty network devices to lose network data packets. Accordingly, it may be assumed that data packets containing messages may be lost. Also, it may be assumed that the latency to deliver data packets that are not lost is at most a value d. Also, it may be assumed that probability of a message loss is a value l. Accordingly, after x attempts of transmitting a message, the probability that no message is received is l^{x}. Here, the term join is defined to be the timeout for a follower process to detect the failure of the current leader process, and the term retx is defined to be the timeout for message retransmission. If timeout is defined to be:

timeout=x·retx+join+d(1)

for some value of x, then the probability that a process pi receives a broadcast from a sender pj is at least (1-l^{x}). Note that equation (1) assumes that it takes join for pj to detect the failure of the leader, that the time for pi to exchange messages with a subset of processes that form a quorum is negligible. If either pj detects the failure of the previous leader before join or pi takes more time to exchange messages with a subset forming a quorum, then the probability of success is higher. It may also be assumed that channels may propagate messages in parallel. In shared-medium networks, there may be only a single channel, and the single channel may only propagate one message at a time. In such cases, a process pi may add at least one d for every process from which pi has not received a message.

This observation implies that the probability of a process pi receiving a message from a non-faulty process pj after receiving the same proposal from a quorum of processes may be at least (1-l^{x}). Assuming no further failures other than the one of the previous leader, a correct process pi may receive a message from every other non-faulty process with probability (1-l^{x}) before electing a new leader. Process pi then may eventually terminate after assuming that: every correct process receives broadcast messages with probability of at least (1-l^{x}) from all correct processes, and that if all correct processes receive the same set of proposals, then all correct processes terminate with the same proposed leader.

If multiple failures are to be tolerated during a leader election having high probability, then the possibility that faulty processes may send messages to only a subset of processes may be considered. Thus, equation to compute timeout may be modified to the following:

timeout=(f+1)·(x·retx)+join+f·d(2)

where f is a threshold on the number of process failures during the execution of the leader election protocol. To obtain Equation 2, the possibility that a correct process pi may receive a leader proposal from a third process pk. This may happen, for example, if process pj fails. Moreover, if there are multiple failures, then a sequence of messages may occur that begins with process pj and finishes with process pi such that every process in this sequence is only able to send a message to the following process in the sequence. As before, the probability that a correct process pi does not receive the proposal of a faulty process pj after receiving the same proposal from a quorum and waiting for timeout is (1-l^{((f+1)·x)}). Process pi then may eventually terminate after assuming that: every correct process receives broadcast messages with probability of at least (1-l^{x}) from all correct processes, and that if all correct processes receive the same set of proposals, then all correct processes terminate with the same proposed leader.

In operation, election process 100 may ensure that the process that has the most up to date information on the current state of the actions of group of processes 102 is elected to be leader, through the use of the transactional identifier. Additionally, election process 100 may operate to have members of the group of processes broadcast their initial election votes without waiting for any information from the other members of group of processes 102. Accordingly, election process 100 operates as a push-type communication which has the advantage of accelerating the potential speed of the election, as compared with push-based schemes in which processes have to wait for other ones to enter a leader election phase. As used herein the term “push-type communications” may refer to a style of communication protocol where a request for a transmission of information originates with a sender of the information, whereas the term “pull-type communications” may refer to a style of communication protocol where a request for a transmission of information originates with a receiver of the information, or client. Additionally, procedure 100 may operate to provide failure-free leader elections along with timely delivery of all processes deciding upon the same leader within two communication rounds. For example, procedure 100 may operate to guarantee that eventually all operational processes converge to the same leader, even though no process may individually be able to tell when such a state has been reached. Further, procedure 100 may operate to provide leader elections where no election cycle elects two distinct processes.

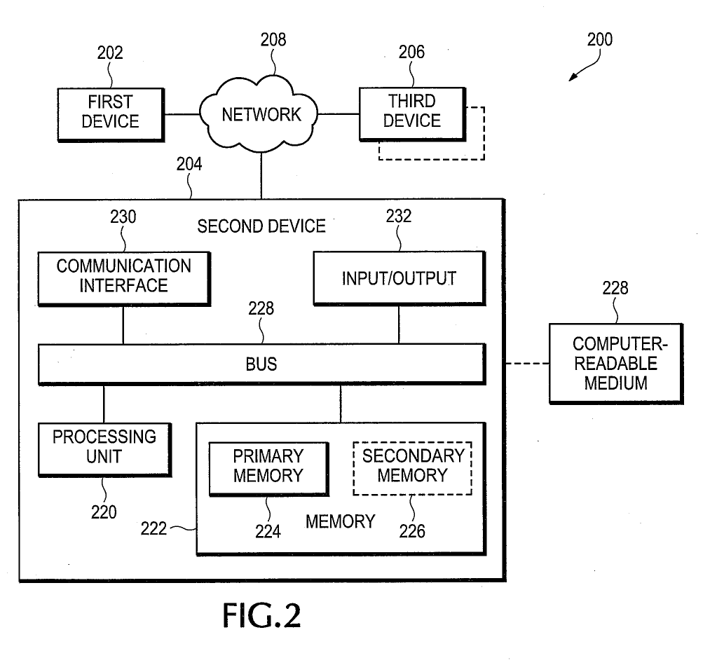

FIG. 2 is a schematic diagram illustrating an exemplary embodiment of a computing environment system 200 that may include one or more devices configurable to process an election of a leader from a group of processes using one or more techniques illustrated above, for example. System 200 may include, for example, a first device 202, a second device 204 and a third device 206, which may be operatively coupled together through a network 208.

First device 202, second device 204 and third device 206, as shown in FIG. 2, may be representative of any device, appliance or machine that may be configurable to exchange data over network 208. By way of example but not limitation, any of first device 202, second device 204, or third device 206 may include: one or more computing devices and/or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet service provider/system, a portal and/or search engine service provider/system, a wireless communication service provider/system; and/or any combination thereof.

Similarly, network 208, as shown in FIG. 2, is representative of one or more communication links, processes, and/or resources configurable to support the exchange of data between at least two of first device 202, second device 204, and third device 206. By way of example but not limitation, network 208 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

As illustrated, for example, by the dashed lined box illustrated as being partially obscured of third device 206, there may be additional like devices operatively coupled to network 208.

It is recognized that all or part of the various devices and networks shown in system 200, and the processes and methods as further described herein, may be implemented using or otherwise include hardware, firmware, software, or any combination thereof.

Thus, by way of example but not limitation, second device 204 may include at least one processing unit 220 that is operatively coupled to a memory 222 through a bus 228.

Processing unit 220 is representative of one or more circuits configurable to perform at least a portion of a data computing procedure or process. By way of example but not limitation, processing unit 220 may include one or more processors, controllers, microprocessors, microcontrollers, application specific integrated circuits, digital signal processors, programmable logic devices, field programmable gate arrays, and the like, or any combination thereof.

Memory 222 is representative of any data storage mechanism. Memory 222 may include, for example, a primary memory 224 and/or a secondary memory 226. Primary memory 224 may include, for example, a random access memory, read only memory, etc. While illustrated in this example as being separate from processing unit 220, it should be understood that all or part of primary memory 224 may be provided within or otherwise co-located/coupled with processing unit 220.

Secondary memory 226 may include, for example, the same or similar type of memory as primary memory and/or one or more data storage devices or systems, such as, for example, a disk drive, an optical disc drive, a tape drive, a solid state memory drive, etc. In certain implementations, secondary memory 226 may be operatively receptive of, or otherwise configurable to couple to, a computer-readable medium 228. Computer-readable medium 228 may include, for example, any medium that can carry and/or make accessible data, code and/or instructions for one or more of the devices in system 200.

Second device 204 may include, for example, a communication interface 230 that provides for or otherwise supports the operative coupling of second device 204 to at least network 208. By way of example but not limitation, communication interface 230 may include a network interface device or card, a modern, a router, a switch, a transceiver, and the like.

Second device 204 may include, for example, an input/output 232. Input/output 232 is representative of one or more devices or features that may be configurable to accept or otherwise introduce human and/or machine inputs, and/or one or more devices or features that may be configurable to deliver or otherwise provide for human and/or machine outputs. By way of example but not limitation, input/output device 232 may include an operatively configured display, speaker, keyboard, mouse, trackball, touch screen, data port, etc.

With regard to system 200, in certain implementations first device 202 may be configurable to process an election of a leader from a group of processes using one or more techniques illustrated above. For example, one such leader election procedure may operate by having first device 202 broadcasting both its process identifier, to identify first device 202, as well as a most current transaction identifier, to identifying how recently first device 202 has been updated. Upon the reception of a pair of a process identifier and a transaction identifier from second device 204, first device 202 may decide to change its vote. For example, first device 202 may decide to change its vote to send an updated leader proposal if such an updated leader proposal would succeed its current leader proposal based, at least in part, on any received transaction identifiers from second device 204. Such procedures for leader elections are described in greater detail above.

It should also be understood that, although particular embodiments have just been described, the claimed subject matter is not limited in scope to a particular embodiment or implementation. For example, embodiments claimed may include one or more apparatuses for performing the operations herein. These apparatuses may be specially constructed for the desired purposes, or they may comprise a general purpose computing platform selectively activated and/or reconfigured by a program stored in the device. The processes and/or displays presented herein are not inherently related to any particular computing platform and/or other apparatus. Various general purpose computing platforms may be used with programs in accordance with the teachings herein, or it may prove convenient to construct a more specialized computing platform to perform the desired method. The desired structure for a variety of these computing platforms will appear from the description above.

Embodiments claimed may include algorithms, programs and/or symbolic representations of operations on data bits or binary digital signals within a computer memory capable of performing one or more of the operations described herein. Although the scope of claimed subject matter is not limited in this respect, one embodiment may be in hardware, such as implemented to operate on a device or combination of devices, whereas another embodiment may be in software. Likewise, an embodiment may be implemented in firmware, or as any combination of hardware, software, and/or firmware, for example. These algorithmic descriptions and/or representations may include techniques used in the data processing arts to transfer the arrangement of a computing platform, such as a computer, a computing system, an electronic computing device, and/or other information handling system, to operate according to such programs, algorithms, and/or symbolic representations of operations. A program and/or process generally may be considered to be a self-consistent sequence of acts and/or operations leading to a desired result. These include physical manipulations of physical quantities. Usually, though not necessarily, these quantities take the form of electrical and/or magnetic signals capable of being stored, transferred, combined, compared, and/or otherwise manipulated. It has proven convenient at times, principally for reasons of common usage, to refer to these signals as bits, values, elements, symbols, characters, terms, numbers and/or the like. It should be understood, however, that all of these and/or similar terms are to be associated with the appropriate physical quantities and are merely convenient labels applied to these quantities. In addition, embodiments are not described with reference to any particular programming language. It will be appreciated that a variety of programming languages may be used to implement the teachings described herein.

Likewise, although the scope of claimed subject matter is not limited in this respect, one embodiment may comprise one or more articles, such as a storage medium or storage media. This storage media may have stored thereon instructions that when executed by a computing platform, such as a computer, a computing system, an electronic computing device, and/or other information handling system, for example, may result in an embodiment of a method in accordance with claimed subject matter being executed, for example. The terms “storage medium” and/or “storage media” as referred to herein relate to media capable of maintaining expressions which are perceivable by one or more machines. For example, a storage medium may comprise one or more storage devices for storing machine-readable instructions and/or information. Such storage devices may comprise any one of several media types including, but not limited to, any type of magnetic storage media, optical storage media, semiconductor storage media, disks, floppy disks, optical disks, CD-ROMs, magnetic-optical disks, read-only memories (ROMs), random access memories (RAMs), electrically programmable read-only memories (EPROMs), electrically erasable and/or programmable read-only memories (EEPROMs), flash memory, magnetic and/or optical cards, and/or any other type of media suitable for storing electronic instructions, and/or capable of being coupled to a system bus for a computing platform. However, these are merely examples of a storage medium, and the scope of claimed subject matter is not limited in this respect.

Unless specifically stated otherwise, as apparent from the preceding discussion, it is appreciated that throughout this specification discussions utilizing terms such as processing, computing, calculating, selecting, forming, transforming, enabling, inhibiting, identifying, initiating, communicating, receiving, transmitting, determining, displaying, sorting, applying, varying, delivering, appending, making, presenting, distorting and/or the like refer to the actions and/or processes that may be performed by a computing platform, such as a computer, a computing system, an electronic computing device, and/or other information handling system, that manipulates and/or transforms data represented as physical electronic and/or magnetic quantities and/or other physical quantities within the computing platform's processors, memories, registers, and/or other information storage, transmission, reception and/or display devices. Further, unless specifically stated otherwise, processes described herein, with reference to flow diagrams or otherwise, may also be executed and/or controlled, in whole or in part, by such a computing platform.

Reference throughout this specification to “one embodiment” or “an embodiment” means that a particular feature, structure, or characteristic described in connection with the embodiment is included in at least one embodiment of claimed subject matter. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “and/or” as referred to herein may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

What is claimed is:

1. A method, comprising:
communicating a current leader proposal by at least one process from a group of processes using at least one computing platform, wherein the current leader proposal comprises a current process identifier and a current transactional identifier;
receiving a leader proposal from at least one other process from the group of processes;
comparing the received leader proposal to the current leader proposal of the at least one process;
communicating an updated leader proposal based, at least in part, on a received leader proposal if the received leader proposal includes a received transactional identifier that is more current than the current transactional identifier of the at least one process; and
selecting a leader from the group of processes based, at least in part, on the updated transactional identifier.

2. The method of claim 1, wherein the updated leader proposal further comprises an updated transactional identifier based, at least in part, on the received transactional identifier.

3. The method of claim 1, wherein the current transactional identifier is based, at least in part, on identifying the most current update of a given process.

4. The method of claim 1, wherein the updated leader proposal further comprises an updated process identifier based, at least in part, on the received process identifier.

5. The method of claim 1, further comprising ending the communication of an updated leader proposal to another process in response to an acknowledgement of receipt by the other process.

6. The method of claim 1, further comprising terminating the selecting a leader from the group of processes based, at least in part, on either receiving a current and/or updated leader proposal from every process in the group of processes or receiving a current and/or updated leader proposal from at least a quorum of processes.

7. The method of claim 1, further comprising waiting for a period of time after the quorum has been reached, and terminating the selecting a leader from the group of processes based, at least in part, on receiving a current and/or updated leader proposal from at least a quorum of processes after expiration of the period of time.

8. The method of claim 1, further comprising terminating the selecting a leader from the group of processes based, at least in part, on receiving a current and/or updated leader proposal from at least a quorum of processes, waiting for a timeout period after the quorum has been reached prior to termination of the selection, and cancelling the timeout period in response to receipt of a current and/or updated leader proposal that includes a received transactional identifier that is more current than the current transactional identifier of the at least one process.

9. The method of claim 1, wherein the current leader proposal further comprises a current counter tag capable of identifying a given election cycle; and
wherein the at least one process compares a received counter tag from the received leader proposal to the current counter tag of the at least one process, ignores the received leader proposal if the received counter tag identifies a past election cycle, and begins an updated election cycle if the current counter tag identifies a past election cycle.

10. The method of claim 1, wherein the group of two or more processes operates in an asynchronous system, and wherein the communication of the current leader proposal and the communication of the updated leader proposal are push-type communications.

11. An article comprising:
a storage medium comprising machine-readable instructions stored thereon which, if executed by a computing platform, result in:
communicating a current leader proposal by at least one process from a group of processes using at least one computing platform, wherein the current leader proposal comprises a current process identifier and a current transactional identifier;
receiving a leader proposal from at least one other process from the group of processes;
comparing the received leader proposal to the current leader proposal of the at least one process;
communicating an updated leader proposal based, at least in part, on a received leader proposal if the received leader proposal includes a received transactional identifier that is more current than the current transactional identifier of the at least one process; and
selecting a leader from the group of processes based, at least in part, on the updated transactional identifier.

12. The article of claim 11, wherein the current transactional identifier is based, at least in part, on identifying the most current update of a given process, and wherein the updated leader proposal further comprises an updated transactional identifier based, at least in part, on the received transactional identifier.

13. The article of claim 11, wherein the updated leader proposal further comprises an updated process identifier based, at least in part, on the received process identifier.

14. The article of claim 11, wherein said machine-readable instructions, if executed by a computing platform, further result in:
terminating the selecting a leader from the group of processes based, at least in part, on receiving a current and/or updated leader proposal from at least a quorum of processes, waiting for a timeout period after the quorum has been reached prior to termination of the selection, and cancelling the timeout period in response to receipt of a current and/or updated leader proposal that includes a received transactional identifier that is more current than the current transactional identifier of the at least one process.

15. The article of claim 11, wherein the current leader proposal further comprises a current counter tag capable of identifying a given election cycle; and
wherein the at least one process compares a received counter tag from the received leader proposal to the current counter tag of the at least one process, ignores the received leader proposal if the received counter tag identifies a past election cycle, and begins an updated election cycle if the current counter tag identifies a past election cycle.

16. An apparatus comprising:
a computing platform, said computing platform being adapted to result in:
communicating a current leader proposal by at least one process from a group of processes using at least one computing platform, wherein the current leader proposal comprises a current process identifier and a current transactional identifier;
receiving a leader proposal from at least one other process from the group of processes;
comparing the received leader proposal to the current leader proposal of the at least one process;
communicating an updated leader proposal based, at least in part, on a received leader proposal if the received leader proposal includes a received transactional identifier that is more current than the current transactional identifier of the at least one process; and
selecting a leader from the group of processes based, at least in part, on the updated transactional identifier.

17. The apparatus of claim 16, wherein the current transactional identifier is based, at least in part, on identifying the most current update of a given process, and wherein the updated leader proposal further comprises an updated transactional identifier based, at least in part, on the received transactional identifier.

18. The apparatus of claim 16, wherein the updated leader proposal further comprises an updated process identifier based, at least in part, on the received process identifier.

19. The apparatus of claim 16, wherein said computing platform is further adapted to result in:
terminating the selecting a leader from the group of processes based, at least in part, on receiving a current and/or updated leader proposal from at least a quorum of processes, waiting for a timeout period after the quorum has been reached prior to termination of the selection, and cancelling the timeout period in response to receipt of a current and/or updated leader proposal that includes a received transactional identifier that is more current than the current transactional identifier of the at least one process.

20. The apparatus of claim 16, wherein the current leader proposal further comprises a current counter tag capable of identifying a given election cycle; and
wherein the at least one process compares a received counter tag from the received leader proposal to the current counter tag of the at least one process, ignores the received leader proposal if the received counter tag identifies a past election cycle, and begins an updated election cycle if the current counter tag identifies a past election cycle.

21. An apparatus comprising:
means for communicating a current leader proposal from a group of two or more processes individually, wherein the current leader proposal comprises a current process identifier and a current transactional identifier;
means for receiving a leader proposal from at least one other process by at least one process from the group of processes, means for comparing the received leader proposal to the current leader proposal of the at least one process, and means for communicating an updated leader proposal based, at least in part, on a received leader proposal if the received leader proposal includes a received transactional identifier that is more current than the current transactional identifier of the at least one process; and
means for selecting a leader from the group of processes based, at least in part, on the updated transactional identifier.

22. The apparatus of claim 21, wherein the current transactional identifier is based, at least in part, on identifying the most current update of a given process, and wherein the updated leader proposal further comprises an updated transactional identifier based, at least in part, on the received transactional identifier.

23. The apparatus of claim 21, wherein the updated leader proposal further comprises an updated process identifier based, at least in part, on the received process identifier.

24. The apparatus of claim 21, the apparatus further comprising:
means for terminating the selecting a leader from the group of processes by at least one process from the group of processes based, at least in part, on receiving a current and/or updated leader proposal from at least a quorum of processes, means for waiting for a timeout period after the quorum has been reached prior to termination of the selection, and means for cancelling the timeout period in response to receipt of a current and/or updated leader proposal that includes a received transactional identifier that is more current than the current transactional identifier of the at least one process.

25. The apparatus of claim 21, wherein the current leader proposal further comprises a current counter tag capable of identifying a given election cycle; and
means for comparing a received counter tag from the received leader proposal to the current counter tag of the at least one process, means for ignoring the received leader proposal if the received counter tag identifies a past election cycle, and means for beginning an updated election cycle if the current counter tag identifies a past election cycle.
